(19) United States
(12) Patent Application Publication
(10) Pub. No.: US 2011/0279834 A1
(43) Pub. Date: Nov. 17, 2011

(54) Apparatus and method of controlling an image forming apparatus

(75) Inventor: Hirobumi Nishida, Kanagawa (JP)

(73) Assignee: Ricoh Company, Ltd., Tokyo (JP)

(21) Appl. No.: 13/064,937

(22) Filed: Apr. 27, 2011

(30) Foreign Application Priority Data
May 13, 2010 (JP) 2010-111029

(51) Int. Cl. H04N 1/60

(52) U.S. Cl. 358/1.9

(57) ABSTRACT

A control apparatus for controlling an image forming apparatus specifies a color measurement area in image data, obtains a measured color of the color measurement area of a multi-color toner image of the image data, constructs an algorithm for control parameter correction, and determines a correction value of a control parameter of the image forming apparatus so as to make the difference between the measured color and an expected color to be smaller.

### CROSS-REFERENCE TO RELATED APPLICATIONS

This patent application is based on and claims priority under 35 U.S.C. §119 to Japanese Patent Application No. 2010-111029, filed on May 13, 2010, in the Japanese Patent Office, the entire disclosure of which is hereby incorporated herein by reference.

### FIELD OF THE INVENTION

The present invention generally relates to an apparatus and method of controlling an image forming apparatus such as a copier, facsimile, and printer.

### BACKGROUND

In image forming apparatuses that form a toner image using electrophotographic method, image density of the toner image may be easily affected as toner adhesion per unit area of the toner image changes. For example, toner adhesion tends to change after printing is consecutively performed or when environmental factors such as humidity or temperature change. In case of forming multi-color images, when toner adhesion changes for a primary color, color tone of multi-color images may be adversely affected. For example, a color balance of L*, a*, and b* of L*a*b* color system may vary. More specifically, colors used by color image forming apparatuses are mainly classified into primary colors and multi-colors. The primary colors are reproduced using only one type of toner. If there are four types of toner including yellow toner, magenta toner, cyan toner, and black toner, any one of colors that can be reproduced using one type of toner is referred to as the primary color. The multi-colors are reproduced using more than one type of toner, such as by superimposing toner of more than one primary color. If toner adhesion of primary color toner changes, the resultant multi-color toner image that is generated by superimposing more than one primary color toner would not have expected color tone.

Japanese Patent Application Publication No. 2008-40441 discloses a color image forming apparatus that stabilizes toner adhesion of a primary toner image by correcting control parameters. The image forming apparatus forms a test pattern image, which are patches of yellow, cyan, magenta, and black colors. The patches of the test pattern image are respectively formed with control parameter values that are different from one another such that toner adhesion per unit area differs among the patches. The control parameters are a combination of developing bias applied to a developing roller of a developing unit, and a charging bias used for uniformly charging a surface of a photoconductor functioning as a latent image carrier. In order to stabilize toner adhesion, the image forming apparatus detects, for each patch, toner adhesion per unit area using an optical sensor. Based on the detection result, the image forming apparatus calculates a slope or y-intercept of a linear approximation line indicating the relationship between the toner adhesion and the developing bias. The image forming apparatus further calculates a developing bias that corresponds to a target toner adhesion using the linear approximation line, and corrects a current set value of the developing bias to the calculated value of the developing bias. Further, the image forming apparatus corrects a current set value of the charging bias based on a predetermined potential value of 200V. The control parameters are corrected as described above for each one of the colors of yellow, cyan, magenta, and black to stabilize toner adhesion of yellow, cyan, magenta, and black toner images, thus resulting in stabilization of color tone of the multi-color toner image.

The above-described technique of stabilizing toner adhesion of primary colors, however, tends to reproduce the multi-color image with colors that are slightly different from the colors that are expected. For example, a green color of a multi-color image tends to be yellowish than a green color that is expected to be produced. This shift in color is thought to be caused by various factors such that it has been difficult to specify which factor is causing such color shift.

### SUMMARY

In view of the above, the inventor of the present invention is developing a color image forming apparatus that enhances color reproducibility using a technique that is different from the above-described technique of stabilizing toner adhesion.

The inventor of the present invention has developed a test color image forming apparatus that enhances color reproducibility using the following technique. For each one of primary colors of yellow, magenta, cyan, and black, the relationship between an output color tone and set values of control parameters is previously determined through experiments. Based on the determined relationship between the output color tone and the control parameters, an algorithm or mathematical model is constructed for each of four primary colors. The four mathematical models are stored in a data storage area of a control apparatus. At a predetermined time, the test color image forming apparatus outputs a multi-color test toner image onto a recording sheet. The colors of the test toner image are measured by a spectrometer to obtain measured colors of the test toner image. The measured colors are compared with colors that are expected to be output to obtain a difference. For each one of primary colors, correction values of respective control parameters to be used for correcting the measured colors are obtained, specifically, based on the difference, the algorithm, an area ratio of a primary toner image in the test toner image, and current set values of the control parameters. Based on the correction values, the current set values of the control parameters are corrected, thus enhancing color reproducibility of the output image.

The test toner image output by the test color image forming apparatus has multi-colors with improved color reproducibility. Further, the inventor of the present invention has observed that the test color image forming apparatus is capable of outputting a toner image of multi-colors other than the multi-colors used for the test toner image, with improved color reproducibility while greatly suppressing the color shift.

The test image forming apparatus has a drawback such that it prints out a test toner image in addition to a toner image that is supposed to be output according to a user instruction. This would require a user to sort the printed sheets into the sheets that are needed, and the sheets that are output for measurement purposes. Due to excessive work, it is not practical to use the above-described technique, which requires output of the test toner image.

In view of the above, an objective of the present invention is to provide an image forming apparatus, and an apparatus and a method of controlling an image forming apparatus, each of which is capable of forming a toner image with improved color reproducibility without requiring output of a test toner image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a selected portion of an image forming apparatus according to an example embodiment of the present invention;

FIG. 2 is an enlarged view of an image forming unit of the image forming apparatus of FIG. 1;

FIG. 3 is a schematic block diagram illustrating electric connections of various units in the image forming apparatus of FIG. 1;

FIG. 4 is a schematic block diagram illustrating a main controller and its peripheral section of the image forming apparatus of FIG. 1;

FIG. 5 is a flowchart illustrating operation of printing a toner image while performing feedback control to improve color reproducibility, performed by the main controller of FIG. 4, according to an example embodiment of the present invention;

FIG. 6 is an illustration of example image data supplied to the image forming apparatus of FIG. 1;

FIG. 7 is an illustration of a color measurement area applicable to color measurement detected in the example image data of FIG. 6;

FIG. 8 is a schematic block diagram illustrating a process flow of feedback control mechanism that feedbacks the color measurement obtained from the color measurement area of the image data to output a correction value of a control parameter of the image forming unit;

FIG. 9 is a graph illustrating the relationship between the L* value of cyan color and set values of control parameters of the image forming unit, according to an example embodiment of the present invention;

FIG. 10 is a graph illustrating the reference trajectories of the L* output value used for control parameter correction and the estimated trajectories of the L* output value after correction, according to an example embodiment of the present invention;

FIG. 11 is a graph illustrating the reference trajectories of the a* output value used for control parameter correction and the estimated trajectories of the a* output value after correction, according to an example embodiment of the present invention;

FIG. 12 is a graph illustrating the reference trajectories of the b* output value used for control parameter correction and the estimated trajectories of the b* output value after correction, according to an example embodiment of the present invention;

FIG. 13 is a graph illustrating estimated trajectories and actual trajectories of output values of L, a, and b, according to an example embodiment of the present invention;

FIG. 14 is a graph illustrating estimated trajectories and actual trajectories of control parameters, according to an example embodiment of the present invention;

FIG. 15 is a graph illustrating estimated trajectories and actual trajectories of control parameters, according to an example embodiment of the present invention;

FIG. 16 is an illustration of an example patch pattern image to be used for constructing a mathematical model; and

FIGS. 17A to 17J are a list of equations illustrating calculation performed by the main controller of FIG. 4, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

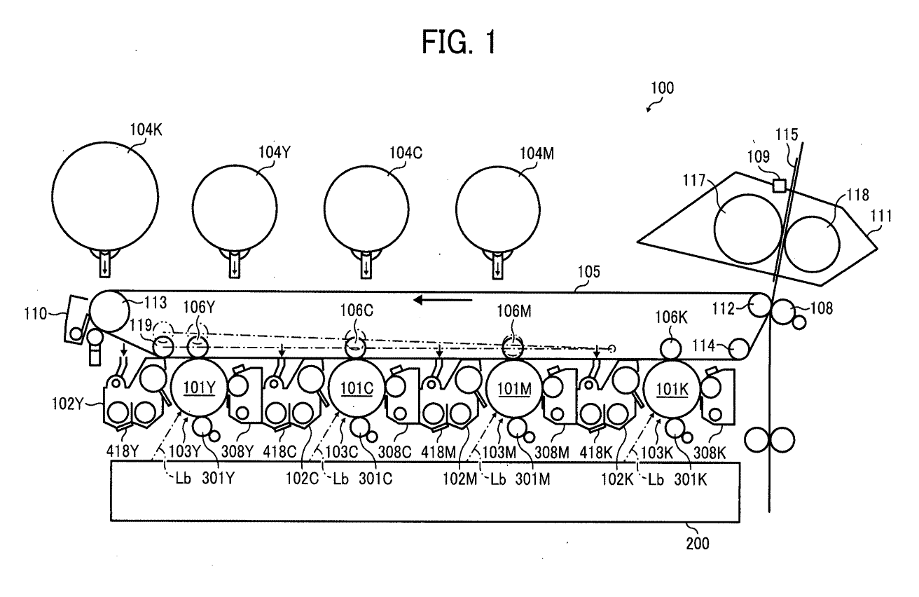

Referring now to FIG. 1, a structure of an image forming apparatus 100 is explained according to an example embodiment of the present invention. In this example, the image forming apparatus 100 is implemented by a color production printer with high-volume and high-speed printing capability. For example, the image forming apparatus 100, which may be referred to as the printer 100, is capable of printing tens of millions of invoices or receipts in about one week. More specifically, the printer 100 operates for at least few hours to continuously output several hundreds of printed documents per one minute.

FIG. 1 illustrates a structure of a selected portion of the printer 100, which includes a process engine section that performs image formation using electrophotographic method. The operation of image formation includes, for example, exposing, charging, developing, transferring and fixing. The printer 100 further includes a sheet tray for storing therein a stack of recording sheets, a sheet feeding device that transfers a recording sheet 115 from the sheet tray to the process engine section shown in FIG. 1, a manual feed tray for allowing a user to manually feed the recording sheet 115 toward the process engine section, and a discharge tray from which the recording sheet 115 having the printed image thereon is discharged.

Referring to FIG. 1, the process engine section of the printer 100 includes four image forming units 103Y, 103C, 103M, and 103K, four toner bottles 104K, 104Y, 104C, and 104M, an intermediate transfer belt 105, four support rollers 112, 113, 114, and 119, primary transfer rollers 106Y, 106C, 106M, and 106K, and an image writing unit 200.

The intermediate transfer belt 105, which is an endless belt, is stretched over the support rollers 112, 113, 114, and 119, and is rotated in the counterclockwise direction as the support roller 112 functioning as a drive roller is rotated. The support rollers 113, 114, and 119 rotate together with rotation of the support roller 112.

The image forming units 103Y, 103C, 103M, and 103K are disposed below the intermediate transfer belt 105. The image forming units 103Y, 103C, 103M, and 103K are substantially similar in function and structure except for the color of toner being used. In this example, Y, C, M, and K respectively correspond to yellow, cyan, magenta, and black. The image forming unit 103Y, 103C, 103M, and 103K respectively include a photoconductor 101Y, 101C, 101M, and 101K, a developer 102Y, 102C, 102M, and 102K, and a charger 301Y, 301C, 301M, and 301K. For the descriptive purposes, the image forming units 103Y, 103C, 103M, and 103K are collectively referred to as the image forming unit 103.

The primary transfer rollers 106Y, 106C, 106M, and 106K are disposed within a loop formed by the intermediate transfer belt 105 at the positions that face the photoconductors 101Y, 101C, 101M, and 101K, respectively. The primary transfer rollers 106Y, 106C, 106M, and 106K press the belt 105 against the photoconductors 101Y, 101C, 101M, and 101K to form primary transfer nips at the positions where the photoconductors 101Y, 101C, 101M, and 101K and the belt 105 are made in contact.

The toner bottles 104Y, 104C, 104M, and 104K are disposed above the intermediate transfer belt 105. The toner bottles 104Y, 104C, 104M, and 104K each contains therein toner to be supplied to the developers 102Y, 102C, 102M, and 102K.

The charger of the image forming unit 103 uniformly charges the surface of the photoconductor 101 with a polarity that is the same with the charging polarity of toner. In FIG. 1, the charger is implemented as a charging brush roller. When charging bias is applied to the charging brush roller, the charging brush roller is made in close contact with the surface of the photoconductor 101 to charge the surface of the photoconductor 101. Alternatively, the charger may be implemented as any desired charger such as a scorotron charger.

The image writing unit 200 is disposed below the image forming units 103Y, 103C, 103M, and 103K. The image writing unit 200 mainly includes a light source such as a semiconductor laser, and a lens mechanism such as a polygon mirror. The image writing unit 200 drives the semiconductor laser according to image data that is received from the external computer to irradiate light beams Lb of respective colors of Y, M, C, and K. With the polygon mirror, the light beams Lb are scanned in the main scanning direction onto the surfaces of the photoconductors 101Y, 101C, 101M, and 101K, respectively. In this manner, the latent images of Y, C, M, and K colors are respectively formed on the surfaces of the photoconductors 101Y, 101C, 101M, and 101K. In alternative to the semiconductor laser, any desired light source may be used such as a light emitting diode (LED).

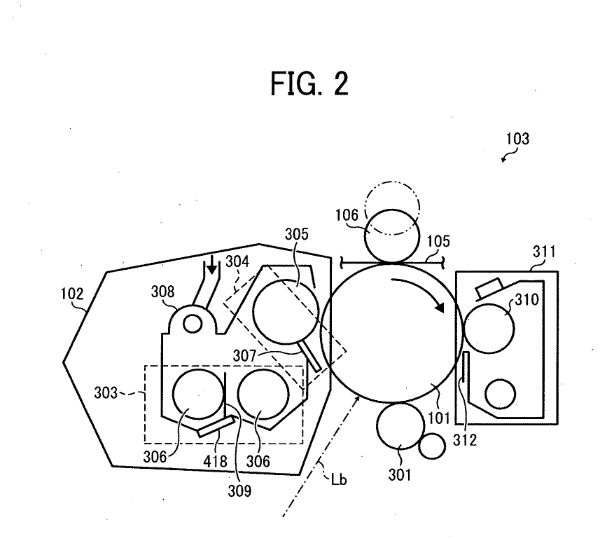

Referring now to FIG. 2, a structure of the image forming unit 103 is explained according to an example embodiment of the present invention.

The image forming unit 103 includes the charger 301, the developer 102, and a cleaner 311, in the circumferential direction of the photoconductor 101. As described above referring to FIG. 1, the primary transfer roller 106 is disposed at the position that faces the photoconductor 101 via the belt 105. In alternative to the primary transfer roller 106, any device functioning as a primary transfer unit may be used such as a conductive blush-type transfer unit or non-contact type corona charger.

In this example, the charger 301 is implemented as a charging roller of contact-type. The charger 301 uniformly charges the surface of the photoconductor 101 by applying voltage to the photoconductor 101 while being in contact with the surface of the photoconductor 101. In alternative to the contact-type charging roller, the charger 301 may be implemented as a non-contact type charger such as scorotron charger.

The developer 102 contains therein a developing agent having magnetic carrier and non-magnetic carrier. Alternatively, a single component developing agent may be used. The developer 102 includes a developer case 308, which includes a developing sleeve 305 and two screws 306. The developer case 308 of the developer 102 is mainly classified into an agitator section 303 and a developer section 304. The agitator section 303 agitates the two-component developing agent (“developing agent”) and transfers the agitated developing agent to the developing sleeve 305 that functions as a developer carrier.

The agitator section 303 includes the two screws 306 that are arranged in parallel with each other. Between these two screws 306, a separation plate 309 is provided to allow the ends of the screws 306 to be in connection with each other. The developer case 308 further includes a toner density sensor 418 that detects toner density of the developing agent within the developer 102. The developer section 304 transfers the toner that is separated from the developing agent as it is adhered to the developing sleeve 305 to the photoconductor 101.

The developing sleeve 305 is disposed at the position that faces the photoconductor 101 via an opening of the developer case 308. The developing sleeve 305 contains therein a magnet. Further, a doctor blade 307 is provided such that the tip of the doctor blade 307 is made in contact with the developing sleeve 305. In this example, the doctor blade 307 is disposed at the position such that a distance between the doctor blade 307 and the developing sleeve 305 when the doctor blade 307 is made in close contact is about 0.9 mm. In the developer 102, the two screws 306 agitate, circulate, and transfer the developing agent to the developing sleeve 305. The developing agent supplied to the developing sleeve 305 is collected and kept by the magnet. The developing agent collected by the developing sleeve 305 is transferred with rotation of the developing sleeve 305. As the developing agent passes through the doctor blade 307, the doctor blade 307 regulates an amount of the developing agent to be a desired amount. The developing agent that is removed by the doctor blade 307 from the developing sleeve 305 is transferred back to the agitator section 303.

The developing agent is transferred to a developing section where the developing sleeve 305 is made in contact with the photoconductor 101. At the developing section, the developing agent stands up due to the magnet to form a magnet brush. With a developing bias being applied to the developing sleeve 305, a developing electric field is formed to cause the toner in the developing agent to be transferred from the developing sleeve 305 to a latent image portion of the photoconductor 101. As the toner in the developing agent is transferred to the latent image portion of the photoconductor surface, the latent image is developed into a toner image. As the developing agent is transferred from the developing area to a section that is not much affected by the magnet, the developing agent is separated from the developing sleeve 305 and transferred to the agitator section 303. When the toner density sensor 418 detects that the toner density within the agitator section 303 is lowered, the toner is supplied to the agitator section 303.

The cleaner 311 is disposed at the position such that the tip of a cleaning blade 312 is pressed against the surface of the photoconductor 101. The cleaning blade 312 may be made of polyurethane rubber. In this example, to improve the cleaning capability, the cleaner 311 further includes a conductive fur brush 310 that is made in contact with the photoconductor 101. The fur brush 310 is applied with a bias from an electric field roller, such as a metal roller. The electric field roller is pressed with the tip of scraper. The toner removed from the surface of the photoconductor 101 by the cleaning blade 312 and the fur brush 310 is collected in the cleaner 311, and further transferred to a used toner collection unit.

In this example, the photoconductor 101 is 40 mm in diameter. The photoconductor 101 is rotated in the clockwise direction at a linear speed of 200 mm/s. The developing sleeve 305 is 25 mm in diameter. The developing sleeve 305 is rotated at a linear speed of 564 mm/s. The charge amount of the toner in the developing agent, which is supplied to the developing area, is about −10 to −30 μC/g. The distance between the photoconductor 101 and the developing sleeve 305, or the developing gap, is set to be in the range between 0.5 and 0.3 mm. The photoconductor 101 has a photoconductive layer having a thickness of 30 μm. The beam spot of the beam Lb irradiated by the image writing unit 200 has a size of 50×60 μm, with the light level of 0.47 mW. The surface of the photoconductor 101 is uniformly charged by the charger 301, for example, at −700 V. The potential of the latent image formed through scanning by the image writing unit 200 is about −120 V. The developing bias applied to the developing sleeve 305 is about −470 V. With this developing bias, the developing potential of 350 V is formed between the latent image and the developing sleeve 305. Any one of the process parameters may be changed based on control of electric potential.

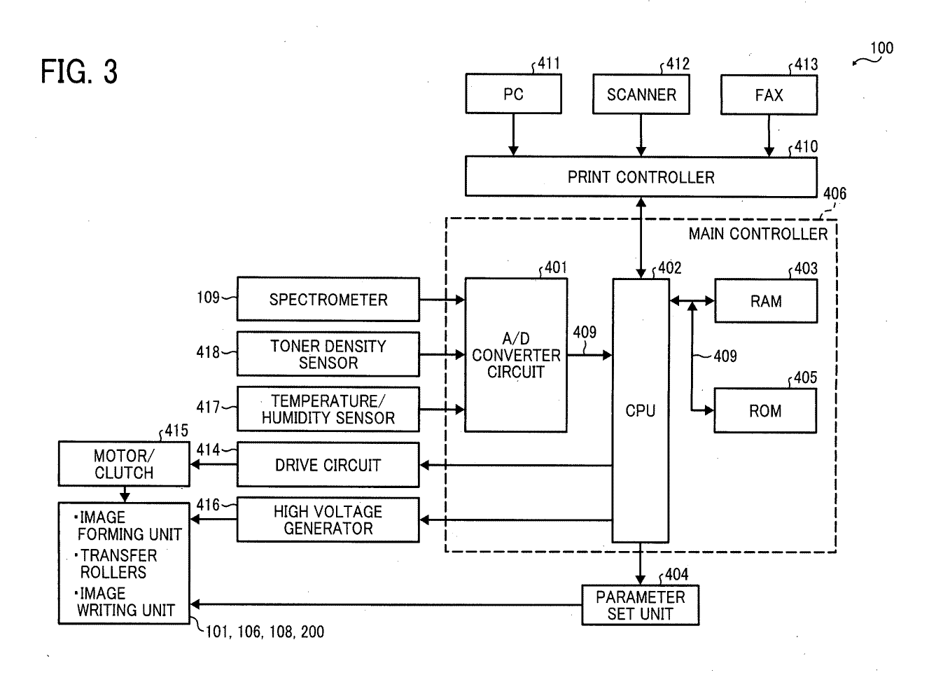

In the image forming unit 103, the surface of the photoconductor 101 that is rotated is uniformly charged by the charger 301. The image writing unit 200 forms a latent image on the surface of the photoconductor 101 by scanning the light beam Lb according to image data received from a print controller 410 (FIG. 3). The developer 102 develops the latent image into toner image such that toner images of Y, M, C, and K are respectively formed. At the primary transfer nip, the toner image is transferred from the surface of the photoconductor 101 to a surface of the intermediate transfer belt 105. The residual toner that resides on the surface of the photoconductor 101 after image transfer is removed by the cleaner 311.

In the above-described manner, the image forming units 103Y, 103C, 103M, and 103K form toner images of Y, C, M, and K onto the surfaces of the photoconductors 101Y, 101C, 101M, and 101K. At the primary transfer nips of Y, C, M, and K, the toner images of Y, C, M, and K are transferred onto the surface of the intermediate transfer belt 105 so as to be superimposed one above the other. In this manner, a color-composite image is formed on the surface of the intermediate transfer belt 105.

Referring back to FIG. 1, the printer 100 further includes a secondary transfer roller 108, which is provided in the outside of the loop formed by the intermediate transfer belt 105. The transfer roller 108 is made in contact with the support roller 112 via the intermediate transfer belt 105 to form a secondary transfer nip. The secondary transfer roller 108 is applied with a secondary transfer bias having a polarity that is opposite of the toner charging polarity. The printer 100 further includes a registration roller below the secondary transfer nip, which transfers the recording sheet 115 toward the secondary transfer nip in synchronization with formation of the color-composite image on the intermediate transfer belt 105. As the recording sheet 115 enters the secondary transfer nip, the color-composite image formed on the intermediate transfer belt 105 is transferred from the intermediate transfer belt 105 onto the recording sheet due to the secondary transfer bias and the nip pressure. In this manner, the recording sheet 115 is printed with a full-color toner image. In this example, the secondary transfer roller 108 may be replaced with a scorotron charger.

The printer 100 further includes a fixing unit 111 that is provided above the secondary transfer roller 108. The fixing unit 111 fixes the full-color toner image formed on the recording sheet 115 to the recording sheet 115. The fixing unit 111 includes a heating roller 117 and a pressure roller 118, which are made in pressure contact with each other. The fixing unit 111 further includes a spectrometer 109, which detects the color of the full-color toner image formed on the recording sheet 115. For example, the spectrometer 109 is described in U.S. Patent Application Publication No. 2005/0240366, published on Oct. 27, 2005, the entire contents of which is hereby incorporated by reference.

Further, as illustrated in FIG. 1, the printer 100 includes a belt cleaning unit 110 in the outside of the loop formed by the intermediate transfer belt 105. The belt cleaning unit 110 is made in contact with the support roller 113 via the intermediate transfer belt 105 to remove the toner from the intermediate transfer belt 105 after the color-composite image is transferred.

FIG. 3 is illustrates the electric connections of various parts in the printer 100. The printer 100 includes a main controller 406 that functions as a controller to control entire operation of the printer 100. More specifically, the main controller 406 controls operation of each part in the printer 100 to form an image using electrophotographic method.

The main controller 406 includes a central processing unit (CPU) 402, a read only memory (ROM) 405, and a random access memory (RAM) 403, which are connected through a bus line 409. The CPU 402 controls entire operation of the printer 100 including calculation of various process or control parameters to be used for image formation. The ROM 405 stores therein various data such as a computer program to control image forming operation. The RAM 403 functions as a work area of the CPU 402 to store various data. The main controller 406 further includes an analog digital (A/D) converter circuit 401, which is connected to the CPU 402 through the bus line 409. For example, the A/D converter circuit 401 converts analog data received from the spectrometer 109, the toner density sensor 418, or a temperature humidity sensor 417, to digital data.

The main controller 406 is connected to a print controller 410, which processes image data and converts the processed image data to exposure data. For example, the print controller 410 receives the image data from a personal computer (PC) 411, a scanner 412, or a facsimile (FAX) 413. The main controller 406 is further connected to a drive circuit 414 that drives a motor/clutch 415, and a high voltage generator 416 that generates voltage needed for an image forming section such as the image forming unit 103, the primary transfer roller 106, the image writing unit 200, and the secondary transfer roller 108.

The main controller 406 is further connected to a parameter set unit 404. The parameter set unit 404 sets various parameters such as the laser intensity of the image writing unit 200, the charge apply voltage of the charger 301, and the developing bias of the developer 102, based on calculation performed by the CPU 402. For example, the CPU 402 calculates a parameter value based on measurement data received from the spectrometer 109 to keep an image density at a desired level.

In printing operation, it is assumed that the printer 100 receives print data including image data to be printed, from the PC 411. The print data is generated by a printer driver installed onto the printer 100. When the print controller 410 receives the print data including the image data from the PC 411, the print controller 410 converts the image data to exposure data, and outputs an instruction for printing to the main controller 406. The main controller 406, which receives the instruction for printing, causes the CPU 402 to operate according to a computer program stored in the ROM 405 to perform image forming using the electrophotographic method. More specifically, the CPU 402 of the main controller 406 drives the motor/clutch 415 through the drive circuit 414, to drive the support roller 112 to cause the intermediate transfer belt 105 to rotate. At the same time, the CPU 402 of the main controller 406 drives the image forming section, which includes the image forming unit 103, the primary transfer roller 106, the image writing unit 200, and the secondary transfer roller 108, through the drive circuit 414, the high voltage generator 416, and the parameter set unit 404.

The main controller 406 drives the motor/clutch 415 through the drive circuit 414 in synchronization with the timing at which the color-composite image formed on the intermediate transfer belt 105 enters the secondary transfer nip to cause the sheet feeding device to feed the recording sheet 115.

The recording sheet 115 fed by the sheet feeding device is transferred to a nip formed between the intermediate transfer belt 105 and the secondary transfer roller 108 to cause the color-composite image to be transferred from the intermediate transfer belt 105 to the recording sheet 115. The recording sheet 115 is transferred to the fixing unit 111 with rotation of the secondary transfer roller 108. The fixing unit 111 fixes the toner image onto the recording sheet 115, by heat and pressure. The recording sheet 115, which passes the fixing unit 111, is discharged onto the discharge tray. The residual toner that resides the surface of the intermediate transfer belt 105 after image transfer is removed by the belt cleaner 110.

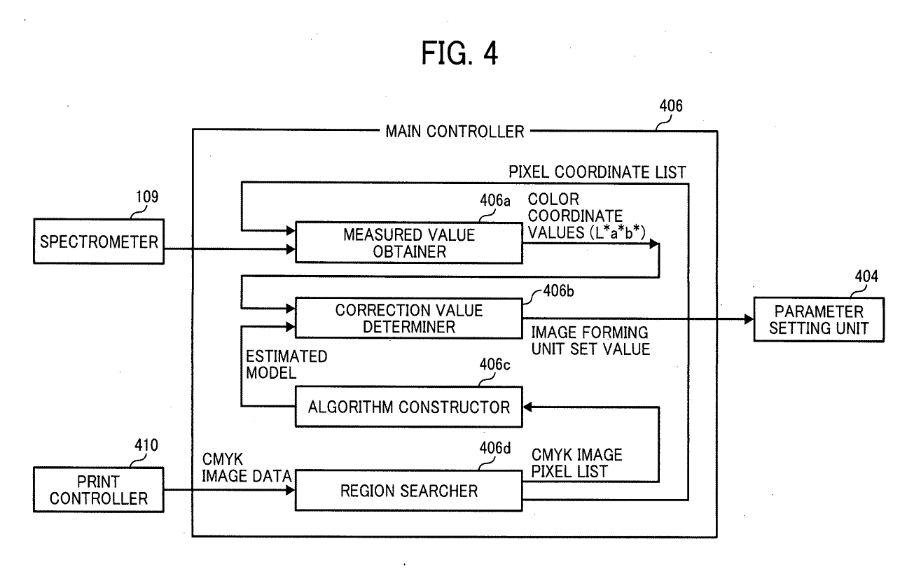

FIG. 4 illustrates the main controller 406 and its peripheral structure. The main controller 406 includes a measured value obtainer 406a, a correction value determiner 406b, an algorithm constructor 406c, and a region searcher 406d, each of which is realized by the program stored in a data storage of the main controller 406.

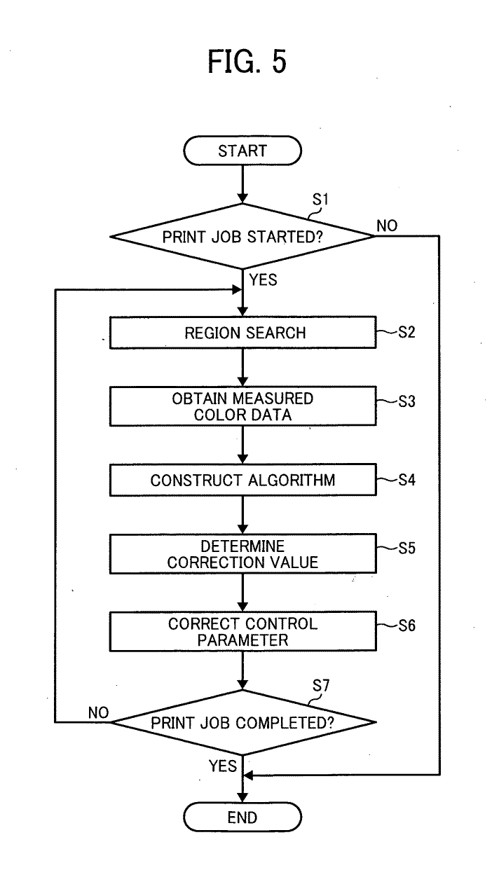

Referring now to FIG. 5, operation of printing an image while performing feedback control to improve color reproducibility, performed by the main controller 406 of FIG. 4, is explained according to an example embodiment of the present invention.

At S1, the main controller 406 determines whether a print job is started. When it is determined that the print job is started (“YES” at S1), the operation proceeds to S2. When it is determined that the print job is not started (“NO” at S1), the operation ends.

At S2, the main controller 406 causes the region searcher 406d (FIG. 4) to perform region searching. The region searcher 406d searches an area that is most suitable for multi-color measurement, based on image data of the image to be output, as a color measurement area. In prior to region searching, the print controller 410 (FIG. 4) obtains the image data of the image to be output, from the external device such as the PC 411, scanner 312, or fax 413 (FIG. 3). More specifically, the image data can be expressed as pixel values of pixels that are arranged in matrix structure, each of which represents the luminance value of color components of red (R), green (G), and blue (B) of the image data. The print controller 410 converts the image data, which is expressed as pixel values of the pixels each representing the luminance value of R, G, and B color components, to the pixel values of the pixels each representing the luminance value of color components of cyan (C), magenta (M), yellow (Y), and black (K). The print controller 410 sends the converted image data to the region searcher 406d of the main controller 406.

The region searcher 406d searches through all regions of the image data specified by the pixel values to determine a region, or an area, that is subjected for color measurement. For example, the region searcher 406d detects one or more areas of the image data with low variance in color tone as such area is more suitable for color measurement.

In this example, the area subjected for color measurement, which may be referred to as the color measurement area, is searched as follows. The region searcher 406d selects a pixel located at a predetermined location in the image pixel matrix as a target pixel. The region searcher 406d further extracts an area having a predetermined size and including the target pixel as well as its surrounding pixels, as an area to be processed. For example, assuming that the region searcher 406d obtains the image pixel matrix of 200 dpi resolution, the region searcher 406d selects a pixel located at 21st in row and 21st in column from the image pixel matrix as a target pixel, and extracts a 5 mm rectangular area of 41 pixels by 41 pixels having the target pixel at its center as an area to be processed. The area of 41 pixels by 41 pixels is equivalent to an area of 61 pixels by 61 pixels in case the image pixel matrix is 300 dpi.

By referring to the pixel value C, M, Y, and K of each pixel in the extracted area, the region searcher 406d calculates the flatness indicating the degree of flatness in tone, or the degree of flatness in lightness or brightness, of color through the entire section of the extracted area.

The flatness may be calculated in various ways. In one example, for each color components of C, M, Y, and K, variance of pixel values is obtained. The flatness in the extracted area is obtained as a negative value of the sum of variance of pixel values obtained for C, M, Y, and K color components.

In another example, the flatness in the extracted area is obtained using variance-covariance matrix. More specifically, for each color components of C, M, Y, and K, variance and covariance of each pixel in the extracted area are obtained. The variance and the covariance are respectively positioned as diagonal elements and non-diagonal elements to construct the 4×4 variance-covariance matrix. The flatness in the extracted area is obtained as a negative value of a solution to this variance-covariance matrix. When compared with the above-described example of obtaining the flatness based on variance of pixel values, the variance-covariance matrix is able to evaluate distribution of colors in the CMYK color space even among different color components.

In another example, the flatness in the extracted area is obtained using frequency characteristics of colors. More specifically, the pixel value of each pixel in the extracted area is applied with Fourier transformation to obtain the squared sum of the absolute value of Fourier coefficients of a specific frequency. The flatness is obtained as a negative value of this squared sum. In this example, for the specific frequency, more than one frequency may be used. In the above-described example of obtaining the sum of variance of pixel values, for images with halftone processing, the flat area may not be accurately detected due to halftone patterns in the image. In contrary, in the example of obtaining the flatness using the frequency characteristics, the use of squared sum of absolute values of Fourier coefficients is not affected by halftone patterns in the image.

When the flatness in the extracted area is obtained, the print controller 410 determines whether all areas to be extracted have been extracted, or area extraction is completed for the entire image. When it is determined that there is an area to be extracted, the region searcher 406d shifts the position of a target pixel by one pixel, and extracts a 5 mm rectangular area of 41 pixels by 41 pixels having the target pixel as its center as an area to be processed. Once the area to be processed is extracted, the region searcher 406d calculates the flatness in tone through the entire section of the extracted area.

For example, the region searcher 406d shifts the position of a target pixel by one pixel toward left with respect to the right end of the matrix to extract an area to be processed next. This process is repeated until the position of a target pixel is shifted to the end of column of the matrix. The region searcher 406d then shifts the position of a target pixel toward right with respect to the left end of the matrix such that the position of the target pixel is located at 21st in column, and further shifts the position of the target pixel by one pixel downward such that the position of the target pixel is located at 22nd in row. For this row, the region searcher 406d repeats the above-described process of shifting the position of a target pixel by one pixel to process the entire section of the image.

In alternative to shifting the target pixel by one pixel, the region searcher 406d may extract an area to be processed such that the area to be extracted does not overlap with the adjacent area that has been previously extracted. For example, after the rectangular area of 41 pixels by 41 pixels having the 21st target pixel as its center is extracted, the region searcher 406d may extract a rectangular area of 41 pixels by 41 pixels having the 62nd row, 62nd column target pixel as its center.

When the region searcher 406d completes calculation of flatness for all extracted areas of the image data, the region searcher 406d selects one of the extracted areas having the flatness that is most desirable, and determines whether the flatness of the selected extracted area is more desirable than a reference flatness value that is previously determined. When it is determined that the flatness of the selected extracted area is more desirable than the reference flatness value, the region searcher 406d determines that the extracted area having the flatness that is more desirable is applicable to color measurement.

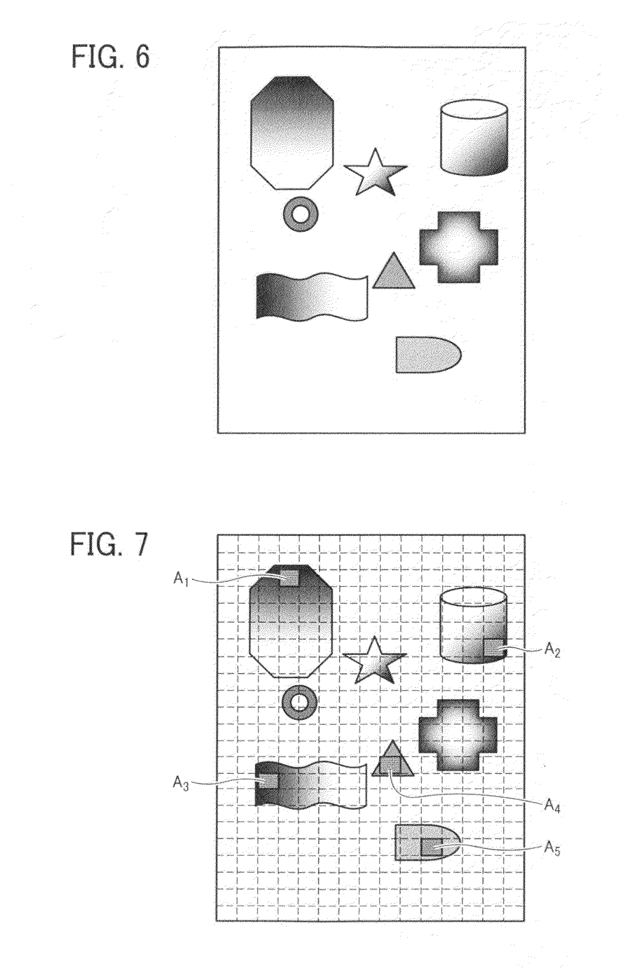

Assuming that example image data of FIG. 6 is processed by the region searcher 406d, the region searcher 406d calculates flatness in color tone for each one of a plurality of areas as illustrated in FIG. 7, and further extracts five areas A1 to A5 for color measurement as the area applicable to color measurement.

After completion of operation performed by the region searcher 406d, at S3, the main controller 406 causes the image forming unit 103 to form a full-color image on the recording sheet 115 based on the image data, and sends the recording sheet 115 having the full-color image thereon to the fixing unit 111. At the fixing unit 111, the spectrometer 109 measures the color of the color measurement area on the recording sheet 115, which is selected by the region searcher 406d for color measurement, to generate a measurement result. The measured value obtainer 406a obtains the measurement result from the spectrometer 109.

Referring back to FIG. 5, at S4, the algorithm constructor 406c (FIG. 4) constructs an algorithm to be used for calculation of correction values of control parameters used for the image forming unit 103. In this example, the control parameters are obtained for the laser intensity (LDP) of the image writing unit 200, the charging apply voltage (Cdc) of the charger 301, and the developing bias (Vb) of the developer 102. The algorithm constructor 406c previously stores, in the ROM 405, four mathematical models each of which indicates the correspondence between the output colors and the set values of control parameters for each of Y, M, C, and K colors. More specifically, the algorithm constructor 406c constructs an algorithm for each color of Y, M, C, and K, based on the color-specific mathematical model stored in the ROM 405, the area ratio of a specific color toner image in the color measurement area, the difference between the measured color and the expected color, and the current set values of control parameters. The measured color is obtained by the spectrometer 109, which measures the color in the printed image, specifically, in the color measurement area. The algorithm constructed by the algorithm constructor 406c is used to obtain correction values of control parameters for each of Y, M, C, and K colors.

At S5, the correction value determiner 406b (FIG. 4) determines correction values based on the algorithm constructed by the algorithm constructor 406c for each of Y, M, C, and K colors. More specifically, in the following examples, the correction value determiner 406b determines, for each one of Y, M, C, and K colors, correction values of the laser intensity (LDP), the charge apply voltage (Cdc), and the developing bias (Vb).

At S6, the parameter set unit 404 (FIG. 4) corrects various control parameters based on the correction values determined at S5.

At S7, the main controller 406 determines whether the print job is completed. When it is determined that the print job is completed (“YES” at S7), the operation ends. When it is determined that the print job is not completed (“NO” at S7), the operation returns to S2 to repeat the above-described steps.

Referring now to FIGS. 6 and 7, S4 of constructing an algorithm is explained in more detail. As illustrated in FIG. 7, it is assumed that the region searcher 406d detects five areas A1 to A5 in the image data of FIG. 6 as areas applicable to color measurement. In such case, the algorithm constructor 406c obtains multi-colors in each of the color measurement areas of the image data for comparison with the measured result, for example, in the form of vector of L*a*b* color space. For multi-colors in each of the areas A1 to A5, the algorithm constructor 406c obtains a 15-dimensional output vector y(k) having the average values of L*, a*, and b* that are measured using the k-th printed image formed onto the recording sheet 115 based on the image data of FIG. 7, and a 15-dimensional target vector r0 having the values of L*, a*, and b* extracted from the image data of FIG. 7.

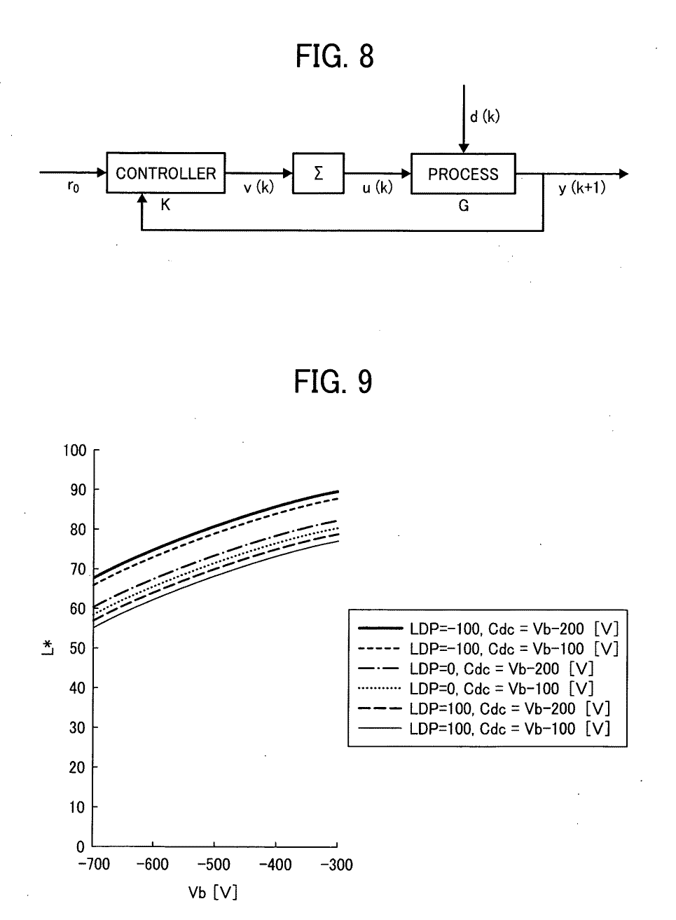

In order to determine a correction value with respect to the control parameter, the main controller 406 functions as a feedback control system as illustrated in FIG. 8. The feedback control system of FIG. 8 includes a controller K, which is input with an output value y(k) obtained by measuring the k-th printed image, and a target value r0 obtained from the image data. Based on the difference between the output value y(k) and the target value r0, the controller K determines a control input v(k) and a set value u(k) of the control parameter. The control input v(k) is a correction value. The relationship between the set value u and the output color y is stored in the ROM 405 in the form of a multivariable function G without a time variable: y=G(u).

More specifically, assuming that the printer 100 is provided with four image forming units 103 respectively for cyan, magenta, yellow, and black, the ROM 405 stores four mathematical models G, or algorithms, each representing the relationship between a control parameter set value u and an output color y for each of the solid-color images of respective colors to be output by the respective image forming units 103.

Assuming that the L* value of cyan in the color measurement area is expressed in terms of polynomial function of the laser intensity (“LDP”) of the image writing unit 200, the charge voltage (Cdc) of the charging unit 301, and the developing bias (Vb) of the developing unit 102, the graph of FIG. 9 is obtained by plotting the L* values of L*a*b* color system with respect to Vb when Cdc and LDP are fixed.

More specifically, the graph of FIG. 9 is expressed as a mathematical model of two dimensions as follows.

L*=0.00021·LDP²−0.000055·Vb²−0.0196·Cdc−0.0537·LDP+0.0196·Vb+83.84.

In addition to the above-described model representing the relationship between L* and various control parameters, for cyan, the ROM 405 stores a mathematical model indicating the relationship between a* and various control parameters, and a mathematical model indicating the relationship between b* and various control parameters.

Similarly, for each one of the other colors of yellow, magenta, and black, the ROM 405 stores three types of mathematical models.

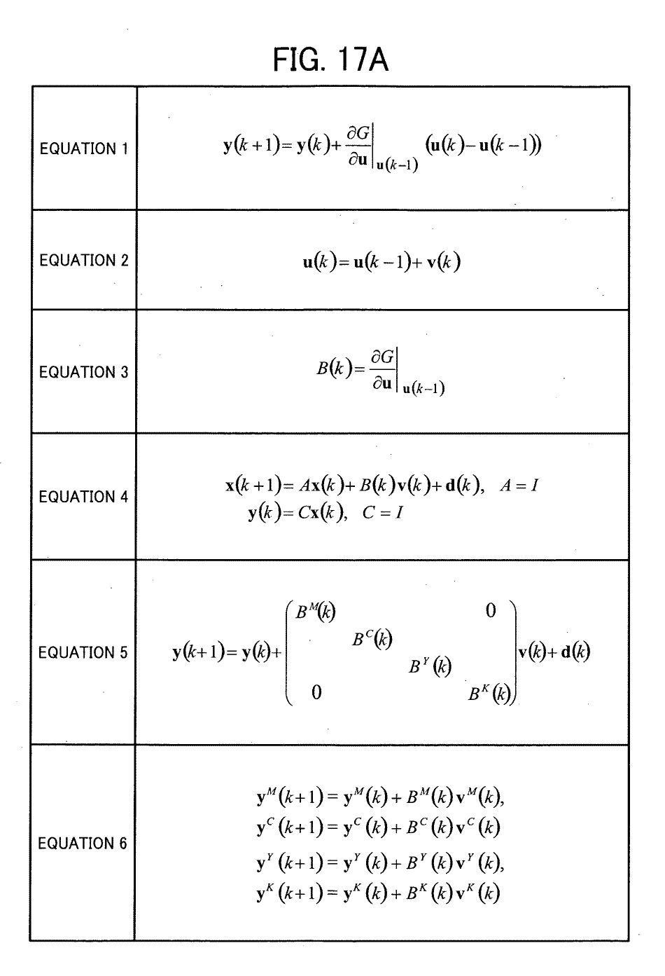

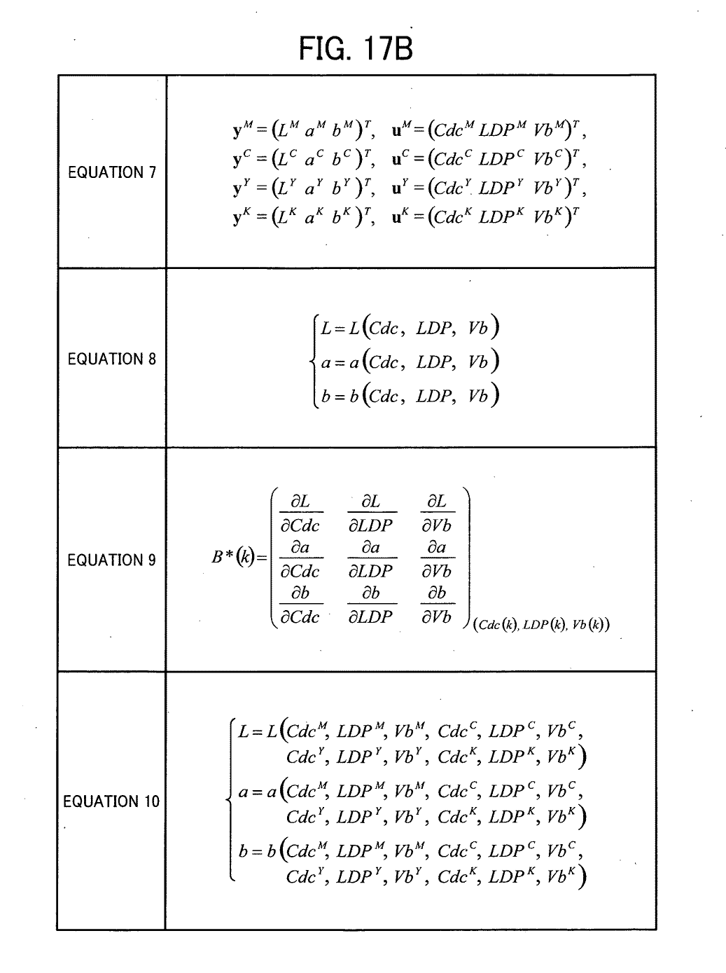

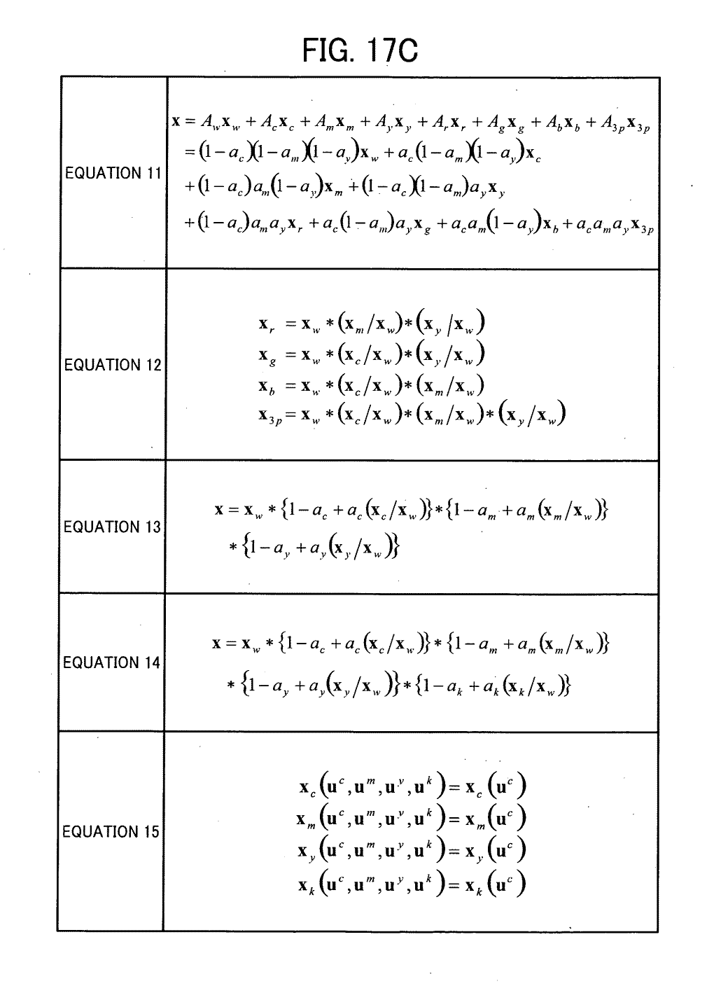

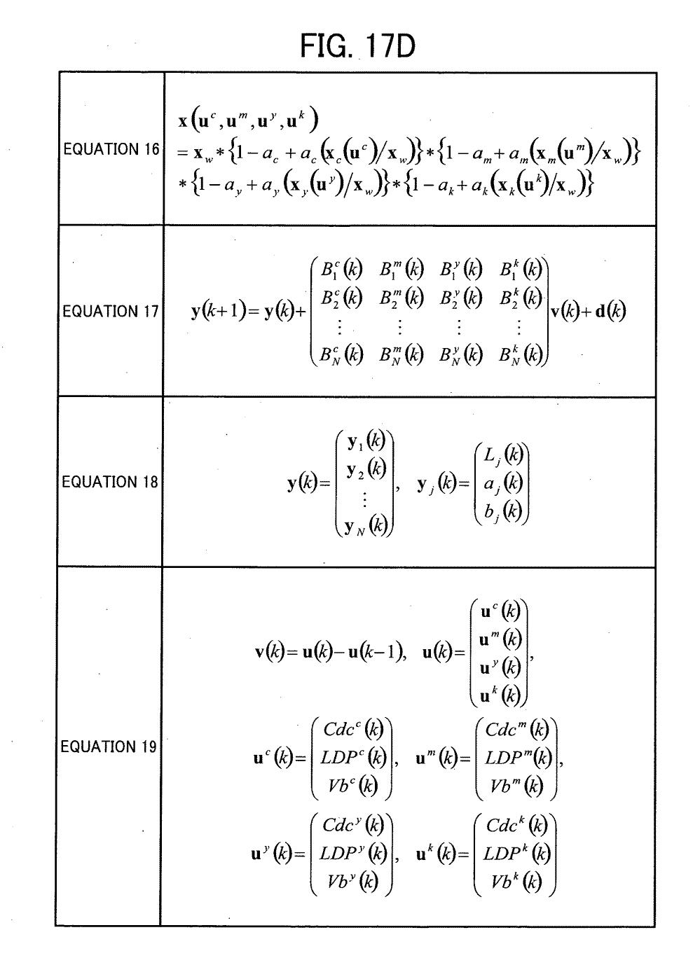

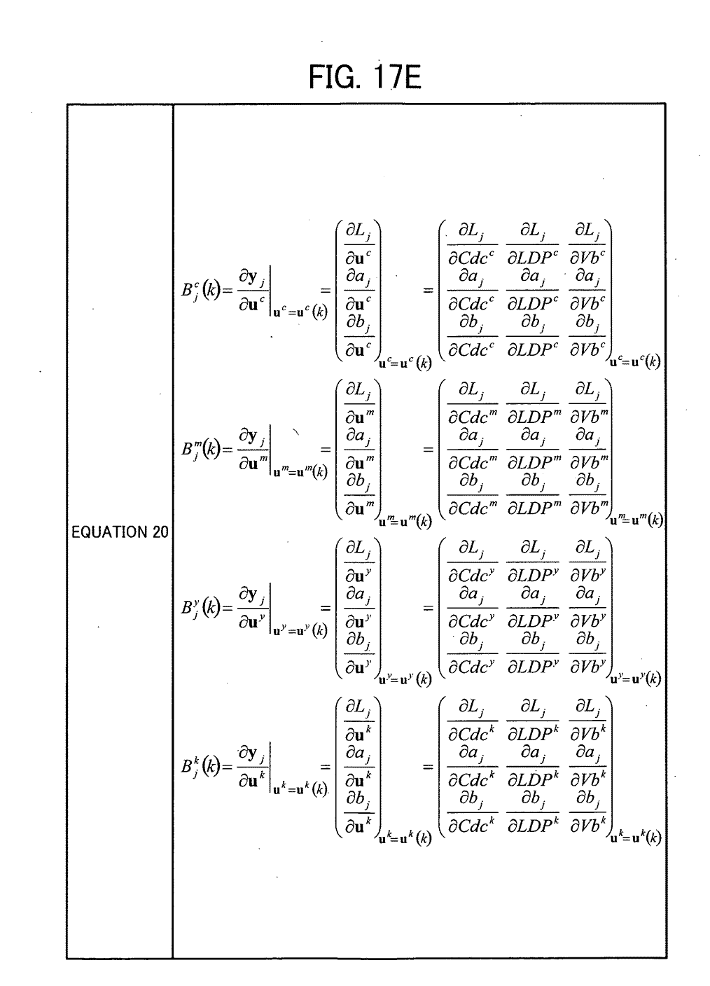

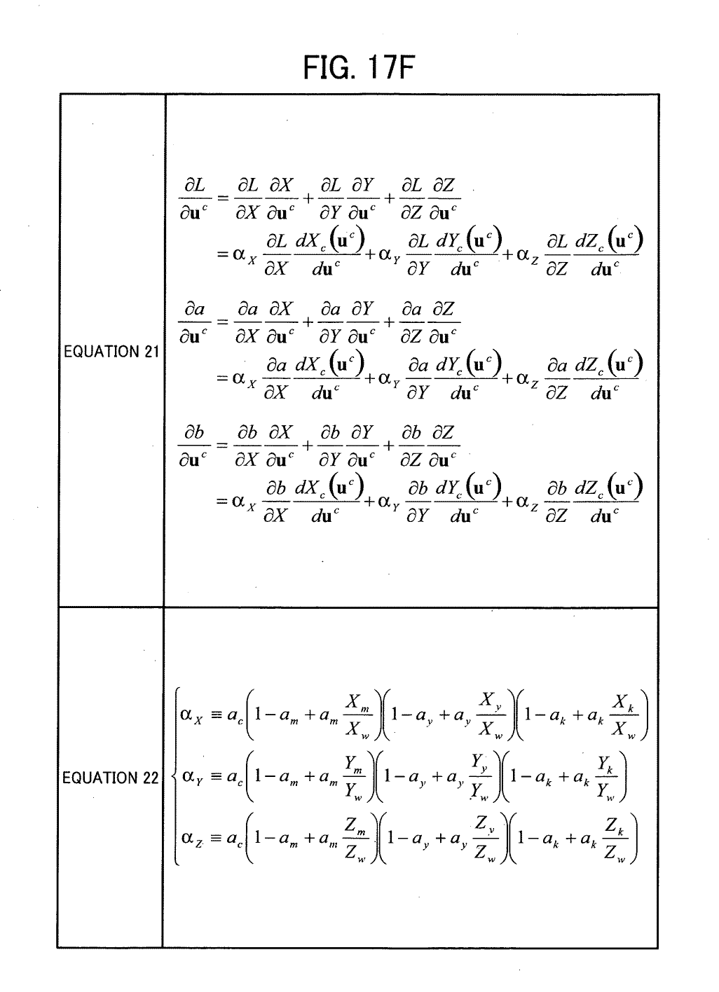

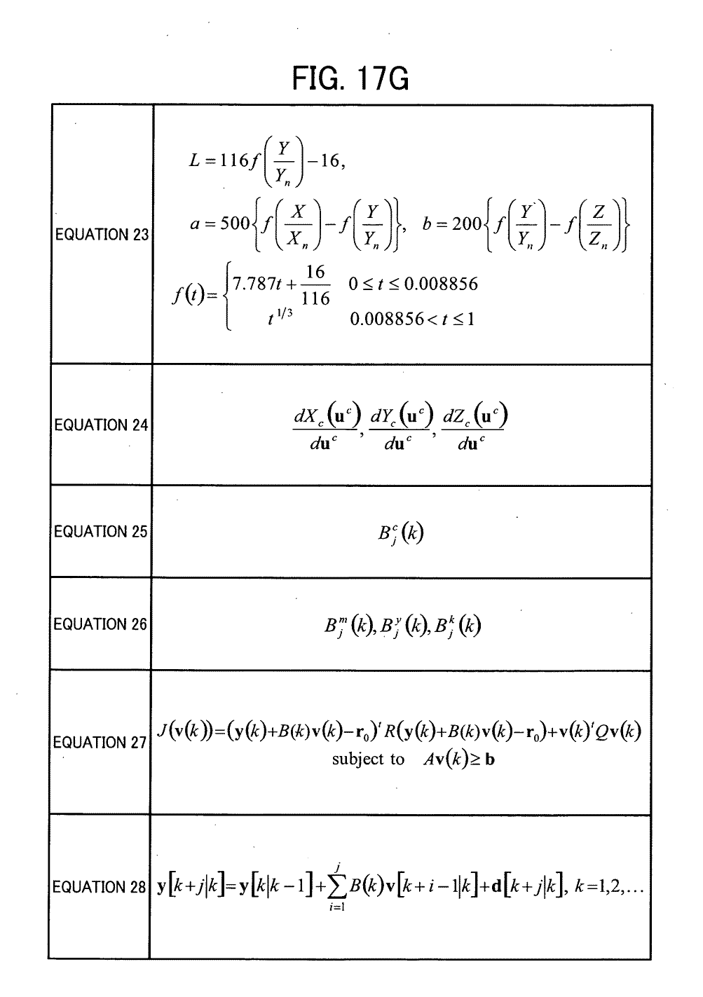

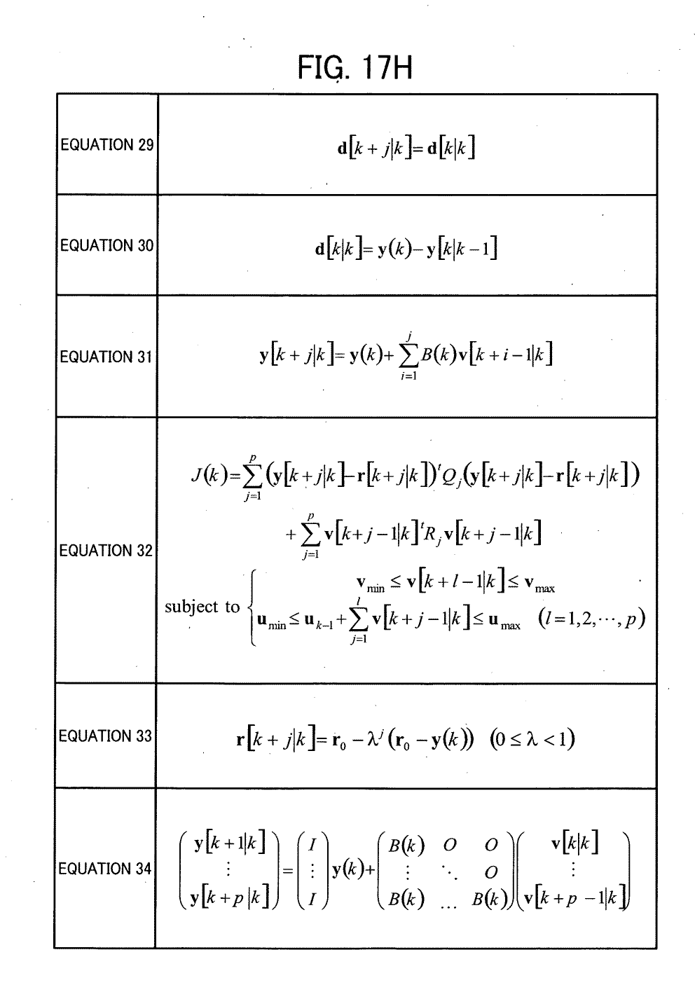

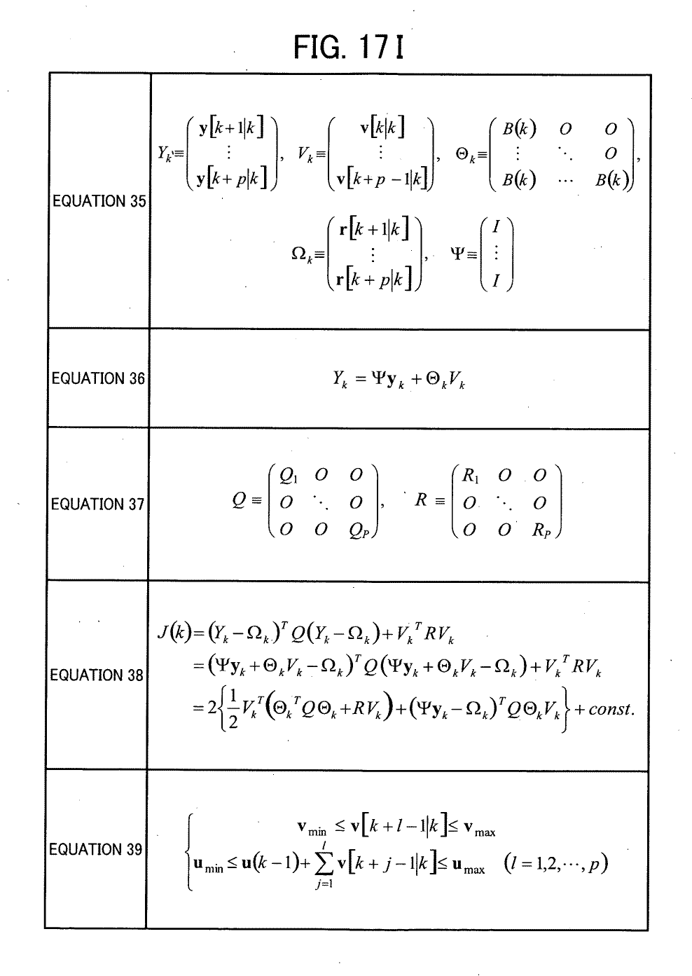

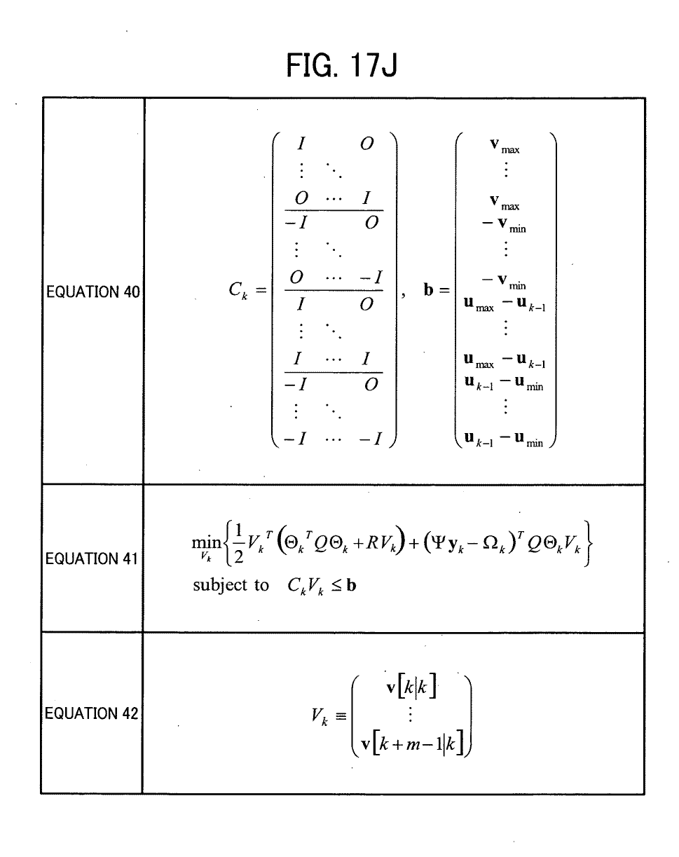

In either case in which the output color y(k) is primary or multi-color, the output color y(k+1) of the printed image (k+1) that follows the printed image k is expressed as the equation 1 of FIG. 17A. The equation 1 is obtained by applying Taylor expansion to the multivariable function G such that the output color initial value y(1) is constructed as an output value with respect to a nominal set value u(0).

The equation 1 is used to determine a control parameter set value u(k+1) of the print process or print step (k+1). The equation 2 of FIG. 17A defines a control input v(k), which is a correction value of the set value u(k) of a current print process or print step k.

As indicated by the equation 3 of FIG. 17A, a series representing the change in output color with respect to the change in control parameter u(k), which is a part of the equation 1, is defined as Jacobian matrix B(k) of the print step k.

In the equation 3, the control parameter u of the Jacobian matrix B(k) is assumed to be fixed. Since the multivariable function G is generally non-linear, the matrix B(k) changes by print step. With the fixed control parameter u, the system of the equation 1 can be expressed in the form of equation 4, which is an equation of state, as a linear time varying system. In the equation 4, x is a state variable, and d is a disturbance. With the equation 4, the control input v(k) is determined in replace of the set value u(k). Further, I indicates an identity matrix.

Since the matrix B(k) depends on the control parameter u(k−1) of the print step k−1, the matrix B(k) may be described as follows: B(k)=B(u(k−1)).

The above-described matrix B(k) is a linear parameter varying (LPV) function. For the print step k, the matrix B(k) changes every time according to the set value u(k−1) of the previous process. With this function, even when the non-linearity of the system in image forming process is great, the system can be effectively controlled.

As illustrated in FIG. 8, for the print step k, the controller K determines the control input v(k) based on the output value y(k) and the target value r0. With the equation 2 of FIG. 17A, the control parameter u(k) is obtained by adding the control input v(k) to u(k−1). The output of the resultant process obtained through the function G with the disturbance d would be the output y(k+1) of the print step k+1.

The algorithm constructor 406c obtains four mathematical models that are stored in the ROM 405 for Y, M, C, and K colors (two-dimensional models), and the measurement results of color measurement areas obtained by the spectrometer 109, to construct mathematical models, or algorithms, each representing the relationship between the control parameter set values and the output color as described below referring to the equation 17 of FIG. 17D.

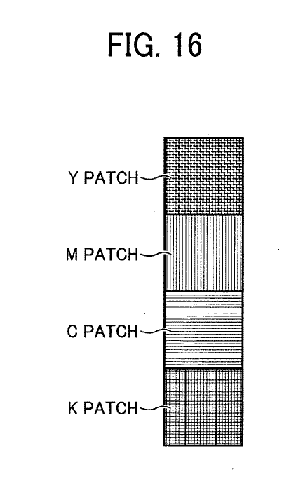

In system modeling, the matrix B(k), which is the change in output with respect to the change in control parameters, is obtained. For example, it is assumed that the printer 100 forms patch pattern images of Y, C, M, and K colors as illustrated in FIG. 16. When the patch of each color is produced with a primary color, the matrix B(k) has a block diagonal structure as expressed by the equation 5 of FIG. 17A.

Accordingly, each system of C, M, Y, and K can be treated as an independent system. In equation 5, the letter “M”, “C”, “Y”, and “K” of the matrix “B” represents the color of magenta, cyan, yellow, and black.

The equations 6 of FIG. 17A and the equation 7 of FIG. 17B are respectively obtained from the equation 5. The “T” of the equation 7 indicates transpose of the matrix.

Further, the L, a, and b of the equation 7 can be defined by the equation 8 of FIG. 17B, as described above referring to FIG. 8, as a function of the laser intensity (LDP) of the image writing unit 200, the charge apply voltage (Cdc) of the charger 301, and the developing bias (Vb) of the developer 102.

When L, a, and b are expressed as a polynomial function of Cdc, LDP, and Vb, as indicated by the equation 9 of FIG. 17B, B^{M}(k), B^{C}(k), B^{Y}(k), and B^{K}(k) are each expressed as the 3×3 matrix. In FIG. 9, the sign “*” of the matrix B corresponds to any one of M, C, Y, and K such that is referred to as a wild-card sign.

When the patch of each color is produced with multi-colors, the matrix B(k) does not have a block diagonal structure as expressed by the equation 10 of FIG. 17B.

More specifically, when the patch of each color is produced with multi-colors, the output color is determined based on 12-dimensional set values. In case of primary color images, the output color is determined based on set values u of the image forming unit 103 of a specific color, which is the set values Cdc, LDP, and Vb. In order to obtain the multivariable function y=G(u), the output color needs to be measured for a combination of these three set values. In case of multi-color images, it would not be practical to obtain the multivariable function for a combination of 12 set values.

In view of the above, in case of multi-color images, a mixed color model such as the Neugebauer model may be used. For simplicity, it is assumed that three image forming units of cyan, magenta, and yellow are provided. Assuming that a vector x is RGB (reflectance) or XYZ (tristimulus) of the mixed color of three colors, the vector x can be expressed as the equation 11 of FIG. 17C using Neugebauer model.

In equation 11, the reference “A” is a weighting factor. The symbol Xw is RGB (reflectance) or XYZ (tristimulus) of paper. The symbol Xc is RGB (reflectance) or XYZ (tristimulus) of cyan. The symbol Xm is RGB (reflectance) or XYZ (tristimulus) of magenta. The symbol Xy is RGB (reflectance) or XYZ (tristimulus) of yellow. The symbol Xr is RGB (reflectance) or XYZ (tristimulus) of mixed color of magenta and yellow. The symbol Xg is RGB (reflectance) or XYZ (tristimulus) of mixed color of cyan and yellow. The symbol Xb is RGB (reflectance) or XYZ (tristimulus) of mixed color of magenta and cyan. The symbol X3p is RGB (reflectance) or XYZ (tristimulus) of mixed color of three colors of cyan, magenta, and yellow. The symbol ac, am, and ay indicate an area of cyan image in unit area, an area of magenta image in unit area, and an area of yellow image in unit area, respectively.

Further, aXb and a/b are defined respectively as a product and a quotient of two vectors a=(a1, a2, a3) and b=(b1, b2, b3) by each element, that is, aXb=(a1·b1, a2·b2, a3·b3) and a/b=(a1/b1, a2/b2, a3/b3), the equation 12 of FIG. 17C can be obtained using Pollak approximation. In the equation 17C, the sign “*” indicates multiplication, which is the same as “X”.

More specifically, Neugebauer model can be expressed in terms of the equation 13 of FIG. 17C. The sign “*” in the equation 13 indicates multiplication.

The above-described analysis may be applied to the case in which four image forming units of C, M, Y, and K colors are provided. More specifically, assuming that reflectance RGB values or tristimulus XYZ values of mixed color of four primary colors is defined as vector x, the vector x could be expressed in terms of the equation 14 of FIG. 17C, using Neugebauer model.

In the equation 14, the sign “*” indicates multiplication, ac indicates an area of black color, and Xk indicates output color (reflectance/tristimulus) of black color.

As defined by the equation 15 of FIG. 17C, the output color (reflectance/tristimulus) for colors of C, M, Y, and K, which are expressed as Xc, Xm, Xy, and Xk are respectively determined based on set values u^{C}=(Cd^{C}, LDP^{C}, Vb^{c}), u^{M}=(Cd^{M}, LDP^{M}, Vb^{M}), u^{Y}=(Cd^{Y}, LDP^{Y}, Vb^{Y}), and u^{k}=(Cd^{K}, LDP^{K}, Vb^{K}) of control parameters of image forming units 103C, M, Y, and K.

Further, the output color Xw (reflectance/tristimulus) of paper does not depend on image formation. Since output color X (reflectance/tristimulus) of an arbitrary color is a function of (u^{C}, u^{M}, u^{Y}, u^{K}), the output color X can be expressed in term of the equation 16 of FIG. 17D. The sign “*” in the equation 16 is multiplication.

Using the equation 15, for an arbitrary color, a mathematical model indicating the relationship between control parameter correction values and output colors (reflectance/tristimulus) is constructed. The equation 17 of FIG. 17D is obtained based on LPV function to represent L*a*b* values of N colors, with N being an arbitrary number of colors.

In the equation 17, the vector y(k) is a vector having L*a*b* values of colors yⱼ(k) of the print step k, with j=1, 2, . . . , N, as defined by the equation 18.

As expressed by the equation 19, the vector v(k) is defined as a difference in the vector u(k) having set values of four image forming units for the print step k.

As expressed by the equation 20 of FIG. 17E, the matrix B(k) is Jacobian matrix of L*a*b* values of each color yⱼ(k), with j=1, 2, . . . , N.

Based on the solutions to the equation 20, the equation 17 can be constructed, which is a mathematical model indicating the relationship between control parameter correction values and output colors (reflectance/tristimulus) for an arbitrary color. The equation 20 can be solved as follows.

Using the equation 16, each element in the Jacobian matrix B(k) can be obtained as expressed, for example, as the equation 21 of FIG. 17F in case of cyan.

α_{X}, α_{Y}, and α_{Z} can be defined by the equation 22 of FIG. 17F.

The partial differentials of L, a, and b with respect to X, Y, and Z can be obtained using the equation 23 of FIG. 17G. Xn, Yn, and Zn are tristimulus values of light.

The vector expressed by the equation 24 of FIG. 17G is previously obtained for the cyan color through experiments, and stored in the ROM 405. Based on the equations 22, 23, and 24, the equation 21 can be solved. Based on the solution to the equation 21, the equation 25, which is the matrix B, can be solved for cyan color.

Similarly, the equations 26, which are the matrix B for the other colors, can be respectively solved such that all elements in the equation 20 can be obtained. With the elements of the equation 20, the equation 17 can be solved.

As described above, the algorithm constructor 406c constructs the equations 17 to 26 as the algorithm. Based on the algorithm, the correction value determiner 406d determines the control input v as a correction value.

In this example, the control input v(k) obtained using the equation 17 may be used as a correction value. In this example, the printer 100 does not use all the values of the control input v(k) as correction values, but at least a portion of the values of the control input v(k). More specifically, in this example, the control input v is determined such that the following conditions are satisfied.

(1) The control input v(k) is determined such that the difference between the output of a next step k+1 and the target value r0 is made smaller so as to reach the minimum value. The difference can be expressed as: ∥y(k+1)−r0∥=∥y(k)+B(k)v(k)−r0∥, with “∥” indicating norm.

(2) The control input v(k) is determined such that the change in control input v can be easily adjusted. For example, scaling factors of each element and the target value that is different by process or module should be easily adjusted. Since the model G of the process includes uncertain factors, the change in control input v should be kept small as possible such that conservativeness and operability can be considered.

(3) The control input v(k) is determined such that a constraint condition with respect to the control input v can be controlled. More specifically, an upper limit or a lower limit should be able to be managed.

In order to satisfy the above-described constraint conditions, it is assumed that the difference between the output value y(k), which is the measurement result, and the target value r0 are gradually made smaller. More specifically, the main controller 406 simulates operation of consecutively printing an image generated based on the image data on a predetermined number of pages, while changing the control parameter value to be smaller for each print step so as to gradually make the difference to be smaller to satisfy the above-described constraint conditions. Based on this simulation, the printer 100 determines the correction values v(k), v(k+1), v(k+2), etc. for consecutive print steps. The correction value v(k) of the first print step is set to an actual correction value. In order to perform this process, the equation 27 of FIG. 17G is provided, which includes the “relevance” term representing the first condition, the “penalty” term representing the uncertain change of the second condition, and the constraint condition term representing the third condition. By solving a quadratic programming problem to minimize the equation 27, the control input v that satisfies these three conditions can be obtained.

In the equation 27, R and Q are each expressed as a positive definite symmetric matrix. R weighs an error of each element, and Q weighs each factor corresponding to the second condition. More specifically, R is a scaling factor of a control value, and Q is a scaling factor of a control input or correction value. Further, the matrix A and the vector b each correspond to the third condition.

In this example, the above-described concept is applied not only to the print step k+1, but also to the subsequent print steps such that the control input v is determined so as to optimize the control system for a longer period of time. For simplicity, such control, performed by the CPU 402, is referred to as “model prediction control”.

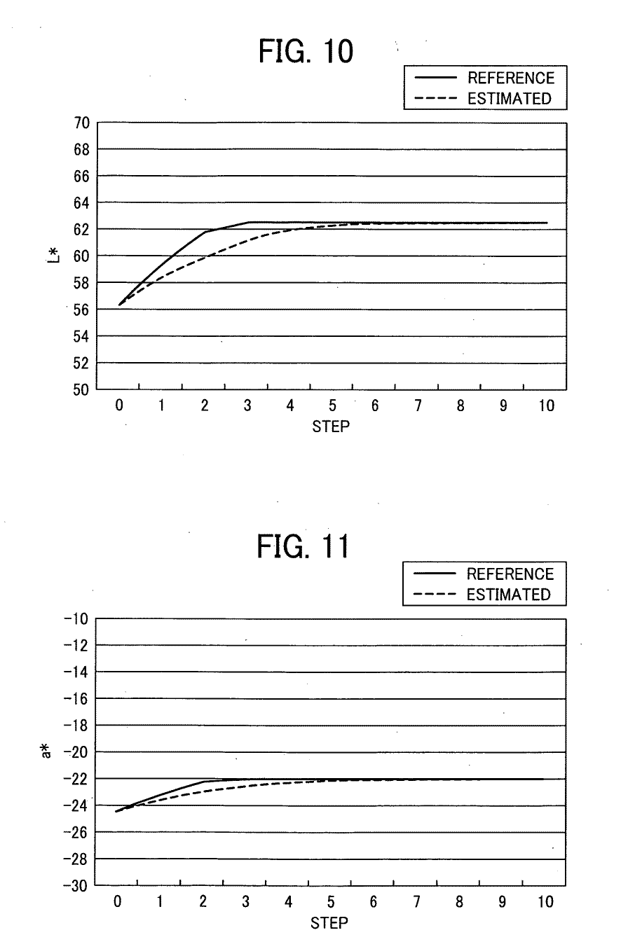

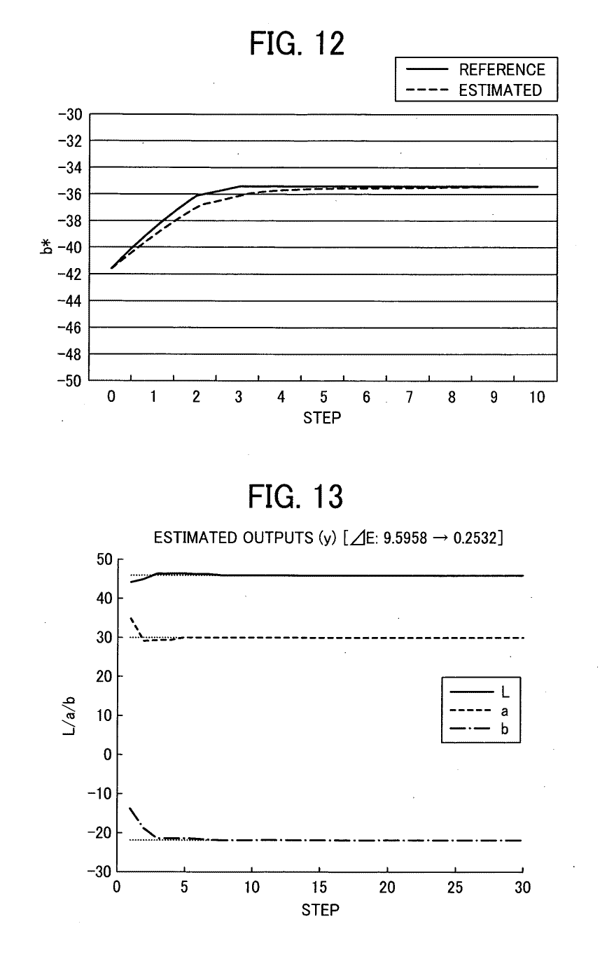

As illustrated in FIGS. 10, 11, and 12, the CPU 402 determines the reference trajectories (r[k+1|k], r[k+2|k], . . . , r[k+j|k]) defining estimated outputs y for print steps (k+1, k+2, k+j) up to jth print steps. Using the equation 27, the CPU 402 obtains the control input matrix (v[k|k], v[k+1|k], . . . , v [k+j−1|k]) such that the outputs (y[k+1|k], y[k+2|k], . . . , y[k+j|k] are made closer to the reference trajectories. In this case, the CPU 402 determines the trajectories while taking into account the penalty term representing the change in control input v and the constraint condition. More specifically, the prediction model of the output values y for steps k+1, k+2, . . . , and constraint evaluation functions for defining the control input v are considered.

FIGS. 10, 11, and 12 illustrate the multi-color output of one of five color measurement areas illustrated in FIG. 7. The output value of each print step, which is the y value, of the trajectories is obtained using the equation 33 of FIG. 17H. The output value of each print step of the estimated outputs is obtained by inputting a solution to the equation 32 to the equation 31 of FIG. 17H. In this graph, a total of 10 print steps are considered such that j=0, 1, 2 . . . , 10.

More specifically, the CPU 402 predicts estimated outputs y for the print steps k+1, k+2, k+10 as follows. The estimated value of the print step k+j is expressed as [k+j|k], and the actual measured value is expressed as (k). The prediction model can be expressed by the equation 28 of FIG. 17G.

Assuming that the disturbance d has a constant value of an output disturbance as defined by the equation 29 of FIG. 17H, the predicted value of the disturbance d can be expressed by the equation 30 of FIG. 17H as the difference between the measured output and the estimated output of the print step k.

Accordingly, the prediction model can be described as the equation 31 of FIG. 17H.

The constraint evaluation function to determine the control input v is defined as follows. The constraint evaluation function at the print step k can be described as the equation 32 of FIG. 17H, with an estimated horizon length p, reference trajectories r, and weighing matrix (positive definite symmetric matrix) Q and R.

The values vmin, vmax, umin, and umax can be set according to specification of the printer 100. The reference trajectories r can be obtained using the equation 33 of FIG. 17H.

The controller K of FIG. 8 calculates the optimum control input matrix (v[k|k], v[k+1|k], v[k+p−1|k]) to minimize the above-described constraint evaluation function using the prediction model 31. The first element v[k|k] is used as v(k), and the control parameter of the print step k is updated using the following equation: u(k)=u(k−1)+v(k).

The optimum control input matrix can be solved as a quadratic programming problem, as explained below. The prediction model, which is the equation 31 of FIG. 17H, may be rewritten as the equation 34.

With the equation 35 of FIG. 17I, the equation 34 of FIG. 17H can be further described as the equation 36 of FIG. 17I.

While considering scaling factor of each correction value as expressed by the equation 37 of FIG. 17I, the constraint evaluation function can be expressed by the equation 38 of FIG. 17I.

The constraint condition expressed by the equation 39 of FIG. 17I can be expressed by the equation 40 of FIG. 17J, with the matrix Ck and vector b. The model prediction control can be defined by the equation 41 of FIG. 17J, which is a quadratic programming problem that provides a solution to an optimum correction value matrix Vk of each step k. Accordingly, the constraint conditions of control parameters can be efficiently determined.

In the equation 41, T indicates transpose of matrix. In order to obtain a solution to the equation 41, an efficient algorithm such as interior point method may be used. In the above-described manner, the correction values of control parameters are obtained.

Referring back to FIG. 5, at S6, the parameter set unit 404 sets the control parameter values such that the correction values of control parameters determined at S5 are reflected. Assuming that the solution to the equation 41 is obtained as the equation 42 of FIG. 17J, in the form of vector Vk, the control parameter of the print step k is updated as the following equation: u(k)=u(k−1)+v(k), using v[k|k] as v(k).

The measured value, which is an output obtained after inputting u(k) as the set value of control parameter, is expressed as y(k+1).

FIG. 13 illustrates the change in output y(k) obtained when operation of FIG. 5 is performed by the printer 100. The horizontal axis of the graph represents a print step, which is a number for identifying paper being output, or a number for identifying feedback control operation in case when feedback control is performed once out of a predetermined number of paper. The output y(k) is the “blue” color, which is reproduced by mixing cyan and magenta. Further, the vertical axis of the graph of FIG. 13 indicates coordinate values of L*a*b* color space. The dotted lines each represent a target value of L*, a*, and b*. For the first print step, the graph of FIG. 13 indicates that the difference ΔE between the target value and the output color is about 9.6. As feedback control is performed in realtime while consecutively printing, the output value y is gradually made closer to the target value.

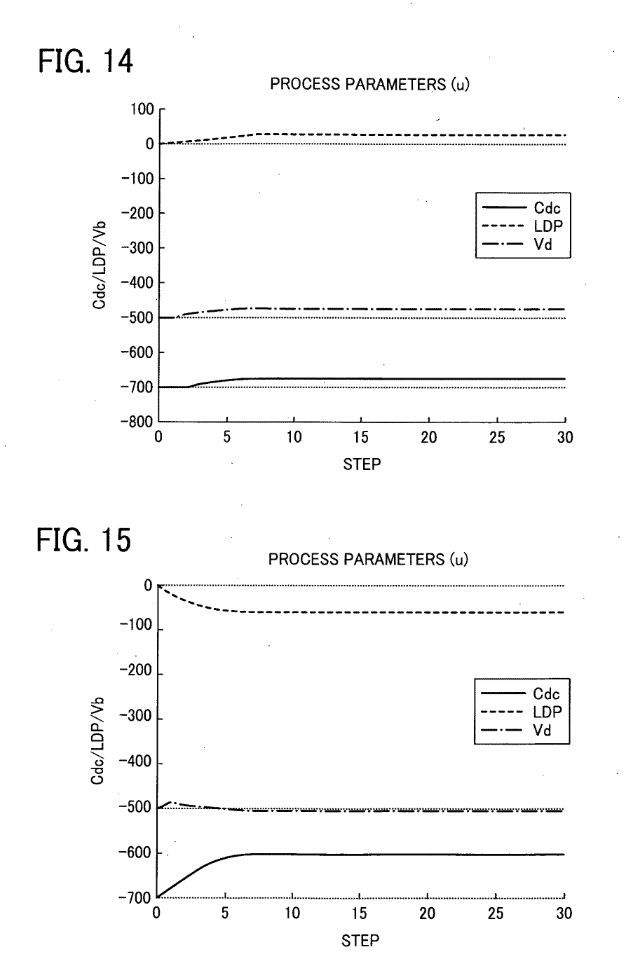

FIGS. 14 and 15 each illustrate the change in control parameter set value u(k) when operation of FIG. 5 is performed by the printer 100. The horizontal axes of FIGS. 14 and 15 each represents a print step, which is a number for identifying paper being output, or a number for identifying feedback control operation in case when feedback control is performed once out of a predetermined number of paper. The vertical axis of the graph of FIG. 14 represents set values of laser intensity (LDP) of the image writing unit 200, the charge applying voltage (Cdc) of the charger 301, and the developing bias (Vb) of the developer 102, for cyan image forming unit. The vertical axis of the graph of FIG. 15 represents set values of laser intensity (LDP) of the image writing unit 200, the charge applying voltage (Cdc) of the charger 301, and the developing bias (Vb) of the developer 102, for magenta image forming unit. As feedback control is performed in realtime while consecutively printing, the control parameter is gradually made close to the optimum value.

As described above, in this example, the main controller 406 performs region searching to detect a color measurement area suitable to multi-color measurement. The main controller 406 previously stores information indicating output colors for Y, C, M, and K toner images respectively formed by the image forming units 103Y, 103C, 103M, and 103K. The main controller 406 constructs a plurality of mathematical models, or algorithms, each indicating the relationship between the output color and control parameter set value for each of colors. The spectrometer 109 measures the color in the color measurement area of the multi-color toner image generated based on image data to obtain a measured result. The main controller 406 further obtains the difference between the measured result (y(k)) and the expected color (r0). Based on the mathematical models, the difference, an area ratio of toner image of each color in the color measurement area, and current set values of control parameters, the main controller 406 determines control parameter correction values (v(k)) that minimize the difference. The main controller 406 corrects the control parameters with the correction values to improve color reproducibility of multi-color toner image. In this manner, a multi-color image is output with improved quality, without requiring output of a test pattern image.

In this example, the printer 100 simulates to consecutively print an image generated based on the image data on a predetermined number of pages, while changing the control parameter value to be smaller for each print step so as to gradually make the difference to be smaller to satisfy the constraint conditions. Based on this simulation, the printer 100 determines the correction values for consecutive print steps. The correction value v(k) of the first print step is set to an actual correction value.

In this example, the spectrometer 109 is used to measure color of the toner image after the toner image is fixed onto the recording sheet 115. Alternatively, a spectrometer 109 may measure color of the toner image when the toner image is formed on the intermediate transfer belt 105. In such case, the spectrometer 109 may be provided at a different location.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

For example, examples of the control parameters of the image forming unit are not limited to the above-described combination of the laser intensity (LDP) of the image writing unit 200, the charging apply voltage (Cdc) of the charger 301, and the developing bias (Vb) of the developer 102.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in: a control apparatus provided in an image forming apparatus, the image forming apparatus including: image forming means for forming a primary color toner image of a plurality of colors on a surface of an image carrier based on image data, the image carrier being one or more image carriers; and transfer means for causing a contact member to closely contact with the surface of the image carrier to form a transfer nip and for transferring the primary color toner images to a surface of the contact member or a recording sheet carried by the surface of the contact member to form a multi-color toner image, the control apparatus being configured to control drive of the image forming means and the transferring means and to perform calculation, wherein the control apparatus is further configured to: perform area searching to detect a color measurement area suitable to color measurement from one or more images of the image data; obtain a plurality of algorithms each indicating the relationship between an output color that is previously stored for each one of the plurality of primary color toner images formed by the image forming means, and a set value of a control parameter of the image forming means; obtain a difference between a measured result obtained by measuring means that measures the multi-color toner image of the color measurement area based on the image data, and an expected color; obtain an area ratio of the primary toner image of each one of the plurality of colors in the color measurement area of the multi-color toner image; obtain a current set value of the control parameter; determine a correction value of the control parameter based on the plurality of algorithms, the difference, the area ratio, and the current set value, so as to make the difference to be smaller; and correct the current set value of the control parameter with the correction value to improve color reproducibility of the multi-color toner image.

In another example, the control apparatus is further configured to simulate operation of consecutively outputting the multi-color toner image based on the image data for a predetermined number of times; determine a correction value for each output to cause the control parameter to be gradually corrected such that the difference is gradually changed to smaller values while satisfying a predetermined constraint condition; and correct the control parameter with a first correction value of the determined correction values.

In another example, the image forming apparatus further includes measuring means for measuring color of the multi-color toner image formed based on the image data. The measuring means may be, for example, a spectrometer, or any desired measuring unit capable of measuring color of the toner image.

In the above-described example, the image forming apparatus is able to improve color reproducibility of a multi-color image, without requiring output of a test pattern image. Accordingly, the user is not required to sort out the test printed sheet as the test printed sheet is not output. Further, the image forming apparatus is able to consecutively print out images.

In alternative to forming a test pattern image used for color measurement, in this example, the image forming apparatus measures color of an output image that is printed according to a user instruction. More specifically, the image forming apparatus detects a color measurement area applicable to color measurement from one or more images to be output according to the user instruction, and measures the color of the detected color measurement area in the output image: The image forming apparatus refers to a plurality of algorithms each indicating the relationship between an output color that is previously stored for each one of the plurality of primary color toner images to be formed by an image forming unit, and a set value of a control parameter of the image forming unit; the difference between the measured color and an expected color; an area ratio of each of the primary toner images in the color measurement area; and a current set value of the control parameter, to determine a correction value of the control parameter so as to make the difference to be smaller.

In this manner, the image forming apparatus is able to determine a correction value of control parameter based on the measured result obtained from the color measurement area of the output image, without forming a test toner image to be used for measurement. The image forming apparatus corrects the control parameter with the determined correction value. Accordingly, the user is not required to sort the printed sheets as the image forming apparatus does not print out a test toner image.

In another example, the present invention may reside in: a method of controlling an image forming apparatus performed by a control apparatus provided in the image forming apparatus, the image forming apparatus including: image forming means for forming a primary color toner image of a plurality of colors on a surface of an image carrier based on image data, the image carrier being one or more image carriers; and transfer means for causing a contact member to closely contact with the surface of the image carrier to form a transfer nip and for transferring the primary color toner image to a surface of the contact member or a recording sheet carried by the surface of the contact member to form a multi-color toner image, the control apparatus being configured to control drive of the image forming means and the transferring means and to perform calculation, wherein the method of controlling comprising: performing area searching to detect a color measurement area suitable to color measurement from one or more images of the image data; obtaining a plurality of algorithms each indicating the relationship between an output color that is previously stored for each one of the plurality of primary color toner images formed by the image forming means, and a set value of a control parameter of the image forming means; obtaining a difference between a measured result obtained by measuring means that measures the multi-color toner image of the color measurement area based on the image data, and an expected color; obtaining an area ratio of the primary toner image of each one of the plurality of colors in the color measurement area of the multi-color toner image; obtaining a current set value of the control parameter; determining a correction value of the control parameter based on the plurality of algorithms, the difference, the area ratio, and the current set value, so as to make the difference to be smaller; and correcting the current set value of the control parameter with the correction value to improve color reproducibility of the multi-color toner image.

In another example, the present invention may reside in: a recording medium storing a plurality of instructions which, when executed by a processor, cause the processor to perform the above-described method.

What is claimed is:

1. A control apparatus for controlling an image forming apparatus that forms a multi-color toner image on a recording sheet based on image data using toner of a plurality of primary colors, the control apparatus comprising:
a region searcher unit configured to specify one or more areas in the image data as a color measurement area applicable to color measurement;
a measured value obtainer configured to obtain a measured color of the color measurement area of the multi-color toner image from a measuring unit;
an algorithm constructor configured to construct an algorithm for control parameter correction, based on a plurality of models each indicating the relationship between an output color and a set value of a control parameter of the image forming apparatus for each one of the plurality of primary colors, an area ratio of a specific primary color toner image in the color measurement area of the multi-color toner image, a difference between the measured color of the color measurement area of the multi-color toner image and an expected color of the color measurement area of the image data, and a current set value of the control parameter;
a correction value determiner to determine a correction value of the control parameter using the algorithm constructed by the algorithm constructor so as to make the difference between the measured color and the expected color to be smaller; and
a parameter set unit to correct the current set value of the control parameter with the correction value determined by the correction value determiner to improve color reproducibility of the multi-color toner image.

2. The control apparatus of claim 1, wherein the correction value determiner is further configured to:
simulate operation of consecutively outputting the multi-color toner image based on the image data for a predetermined number of times;
determine correction values of the control parameter for the predetermined number of outputs to cause the values of the control parameter to be gradually corrected for each output such that the difference is gradually made smaller while satisfying a predetermined constraint condition; and
set the correction value of the control parameter to a first correction value of the determined correction values.

3. The control apparatus of claim 2, wherein the constraint condition includes:
a first condition to allow the difference to be made smaller so as to reach the minimum value;
a second condition to allow the change in the correction value of the control parameter to be easily adjustable; and
a third condition to allow the constraint condition with respect to the correction value of the control parameter to be easily controlled.

4. An image forming apparatus, comprising:
an image forming device to form primary color toner images of a plurality of primary colors on a surface of an image carrier based on image data, the image carrier being one or more image carriers;
a transfer device to transfer the primary color toner images to a surface of a contact member or a recording sheet carried by the surface of the contact member to form a multi-color toner image by superimposing the primary color toner images;
a measuring unit configured to measure color of the multi-color toner image; and
a control device configured to control the image forming device and the transfer device, wherein the control device is further configured to:
specify one or more areas in the image data as a color measurement area applicable to color measurement;
obtain a measured color of the color measurement area of the multi-color toner image from the measuring unit;
construct an algorithm for control parameter correction, based on a plurality of models each indicating the relationship between an output color and a set value of a control parameter of the image forming device for each one of the plurality of primary colors, an area ratio of a specific primary color toner image in the color measurement area of the multi-color toner image, a difference between the measured color of the color measurement area of the multi-color toner image and an expected color of the color measurement area of the image data, and a current set value of the control parameter;
determine a correction value of the control parameter using the algorithm so as to make the difference between the measured color and the expected color to be smaller; and
correct the current set value of the control parameter with the correction value to improve color reproducibility of the multi-color toner image.

5. The image forming apparatus of claim 4, wherein the control device is further configured to:
simulate operation of consecutively outputting the multi-color toner image based on the image data for a predetermined number of times;
determine correction values of the control parameter for the predetermined number of outputs to cause the values of the control parameter to be gradually corrected for each output such that the difference is gradually made smaller while satisfying a predetermined constraint condition; and
set the correction value of the control parameter to a first correction value of the determined correction values.

6. The image forming apparatus of claim 4, further comprising:
a fixing device configured to fix the multi-color toner image onto the recording sheet, wherein the measurement unit is provided in the fixing device.

7. The image forming apparatus of claim 4, wherein the image forming device consecutively forms a plurality of multi-color toner images on a plurality of recording sheets, with the current set value of the control parameter that is continuously corrected.

8. A method of controlling an image forming apparatus that forms a multi-color toner image on a recording sheet based on image data using toner of a plurality of primary colors, the method comprising:
specifying one or more areas in the image data as a color measurement area applicable to color measurement;
obtaining a measured color of the color measurement area of the multi-color toner image from a measuring unit;
constructing an algorithm for control parameter correction, based on a plurality of models each indicating the relationship between an output color and a set value of a control parameter of the image forming apparatus for each one of the plurality of primary colors, an area ratio of a specific primary color toner image in the color measurement area of the multi-color toner image, a difference between the measured color of the color measurement area of the multi-color toner image and an expected color of the color measurement area of the image data, and a current set value of the control parameter;
determining a correction value of the control parameter using the algorithm so as to make the difference between the measured color and the expected color to be smaller; and
correcting the current set value of the control parameter with the correction value to improve color reproducibility of the multi-color toner image.

9. The method of claim 8, further comprising:
simulating operation of consecutively outputting the multi-color toner image based on the image data for a predetermined number of times;
determining correction values of the control parameter for the predetermined number of outputs to cause the values of the control parameter to be gradually corrected for each output such that the difference is gradually made smaller while satisfying a predetermined constraint condition; and
setting the correction value of the control parameter to a first correction value of the determined correction values.
